(19) United States
(12) Patent Application Publication
(10) Pub. No.: US 2006/0175355 A1
(43) Pub. Date: Aug. 10, 2006

(54) BEVERAGE DISPENSER

(76) Inventors: Dov Z. Glucksman, Danvers, MA (US); Laura J. Nickerson, Andover, MA (US); Gary P. McGonagle, Lynn, MA (US); Ulrich Bernard Schnacke, Weddington, NC (US)

Correspondence Address: GEORGE A. HERBSTER, 40 BEACH STREET, SUITE 303, MANCHESTER, MA, 01944, US

(21) Appl. No.: 10/906,214

(22) Filed: Feb. 9, 2005

(51) Int. Cl. B65D 37/00; B67D 5/62

(52) U.S. Cl. 222/209; 222/146.6

(57) ABSTRACT

A refrigerated beverage dispenser. A beverage container is carried in a covered refrigerated housing that includes a heat exchanger for maintaining beverage at a predetermined temperature. A dispensing tube provides a conduit for the beverage. To dispense the liquid, a pressure differential is produced whereby the pressure on the liquid in the container is greater than the pressure at a dispensing port.

### FIELD OF INVENTION

This invention generally relates to beverage dispensers. More specifically this invention relates to beverage dispensers that control the temperature of a beverage.

### BACKGROUND OF INVENTION

The prior art discloses a wide range of dispensers that control the temperature of a beverage. These are used in several applications.

For example, U.S. Pat. No. 5,207,148 discloses an automated milk inclusive coffee apparatus with a steam generator that drives a Venturi mixing device. The Venturi mixing device draws milk from a refrigerated source for making milk inclusive espresso beverages. The refrigerated source includes a Peltier refrigeration unit and an air circulation device within an insulated housing.

U.S. Pat. No. 5,572,872 discloses a liquid cooling, storing and dispensing device formed by a covered refrigerated unit with a Peltier thermoelectric refrigeration device, as one example of a heat exchanger, connected to a wall that abuts a carton. In this particular device, a consumer uses a handle on the device to manipulate the dispensing device and container and pour the contents.

U.S. Pat. No. 6,182,863 discloses a beverage dispensing apparatus with a refrigeration structure for carrying a flexible beverage container. Pressure is exerted against the outer surface of the flexible beverage container. This compresses the container and forces the beverage toward a valve. A consumer opens the valve to dispense liquid. The container can be under pressure even when the valve is closed.

U.S. Pat. No. 6,370,883 discloses a device for the thermal control of liquids or beverages contained in a vessel located in a refrigerated container surrounded by a cooling medium in thermal contact with a Peltier thermoelectric refrigeration device. A pump connects to vessel and includes a piston and valves. Operation of the pump compresses air causing the liquid or beverage to be dispensed.

U.S. Pat. No. 6,820,774 discloses non-refrigerating beverage dispensing device that includes a cap for attachment to a beverage container. The cap defines an outlet. An inner tube attaches the cap for insertion into the container and is in communication with the outlet. A second tube extends from the cap to provide selective pumping of air into the container through the inner tube. A valve on an outer tube controls liquid flow which occurs essentially in a siphoning mode.

These and other prior art beverage dispensers have been used in a variety of applications. Recently, however, the popularity of coffee shops has increased dramatically. Some of them have certain requirements that the foregoing and other prior art beverage dispensers do not meet. More specifically, different coffee shops operate in accordance with different business models. In some, the customer orders coffee with the additions of sweeteners or dairy products by coffee shop personnel. In another popular business model to which this invention is particularly adapted, the customer obtains coffee in a cup and then moves to another part of the store to add dairy products and sweeteners. In many facilities using this business model it is highly desirable that the dairy products be fresh for marketing purposes and for overall taste.

This business model has generated certain requirements for dispensing such dairy-like products. For example, any such dispenser must refrigerate the dairy product or beverage in bulk rather than containers for individual portions without the dairy product spoiling over time. Such dispensers must be easy to clean and easy to fill by coffee shop personnel. Customers must find these dispensers easy to use without spilling the dairy product. While prior art devices satisfy some of these requirements, they do no satisfy all of them. What is needed is a refrigerated beverage dispenser that preserves any beverage for prolonged periods of time to minimize spoilage with its attendant costs and that is easy to use by both consumers and coffee shop personnel.

### SUMMARY

Therefore it is an object of this invention to provide a beverage dispenser that refrigerates a beverage, or liquid, and dispenses the beverage in a controlled manner.

Another object of this invention is to provide a refrigerated beverage dispenser for a beverage, or liquid, that minimizes cleaning operations.

Another object of this invention is to provide a refrigerated beverage dispenser that is affordable for use in coffee shops and like businesses.

In accordance with one aspect of this invention, apparatus for dispensing the contents of a liquid container includes a covered refrigerated housing that receives the container. First and second ports are formed in the container. A dispenser extends from the interior of the liquid container to a dispensing outlet at the exterior of the housing through a first port. A pressure differential structure attaches to the housing and includes the second port. This structure increases the pressure on the surface of the liquid in the liquid container over the pressure at the dispensing outlet whereby operation of the pressure differential enabling structure dispenses liquid.

In accordance with another aspect of this invention, a dispenser includes an outer housing that receives a liquid container having a spout. A thermoelectric heat exchanger attaches to the housing and has a cold side and a hot side. A heat sink attaches to the hot side, and a fan directs air across the heat sink. A sleeve receives and positions one side of the liquid container in contact with the cold side thereby to chill the liquid in the liquid container. A fitting engages the liquid container spout and closes the opening through the spout. The fitting has pressurization and dispensing tube ports. A manually operated air pump attaches to the outer housing for directing air under pressure through the pressurization port. A dispensing tube extends from a bottom portion of the liquid container through the dispensing tube port to a dispensing outlet. Operation of the air pump causes liquid to be dispensed from the dispensing apparatus at the dispensing outlet.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view of a beverage dispenser constructed in accordance with this invention;

FIG. 2 is a perspective view taken from the right side of the dispenser shown in FIG. 1;

FIG. 3 is a rear view of the dispenser shown in FIG. 1;

FIG. 4 is a view like FIG. 2 shown with a beverage being dispensed from the dispenser;

FIG. 5 is an exploded view of the dispenser shown in FIG. 1;

FIG. 6 is a cross sectional view taken along lines 5-5 in FIG. 1;

FIG. 7 is a cross section of a disposable dispensing assembly that is included in the beverage dispenser of FIG. 1;

FIG. 7A is an enlarged cross section of a portion of the assembly shown in FIG. 7;

FIG. 8 is an exploded view of a bellows pump that is included in the beverage dispenser of FIG. 1;

FIG. 9 is a cross sectional view of the bellows pump taken along lines 9-9 of FIG. 8; and

FIG. 10 is a detailed perspective view of an internal lid that is included in the beverage dispenser of FIG. 1;

FIG. 11 is an enlarged cross section of a portion of the beverage dispenser in FIG. 1 showing the assembly of the bellows pump in the beverage dispenser;

FIG. 12 is a perspective view of the beverage dispenser in FIG. 1 with the cover opened;

FIG. 13 is a perspective view of the beverage dispenser in FIG. 1 with the cover closed and an actuator retracted;

FIG. 14 is a perspective view of another embodiment of this invention;

FIG. 15 is a cross section view taken along lines 15-15 in FIG. 14; and

FIG. 16 is a bottom view of the beverage dispenser of FIG. 1 modified to notify personnel that the liquid in the beverage dispenser needs to be replenished; and

FIG. 17 is an enlarged cross section view taken along lines 17-17 in FIG. 16.

### DESCRIPTION OF ILLUSTRATIVE EMBODIMENTS

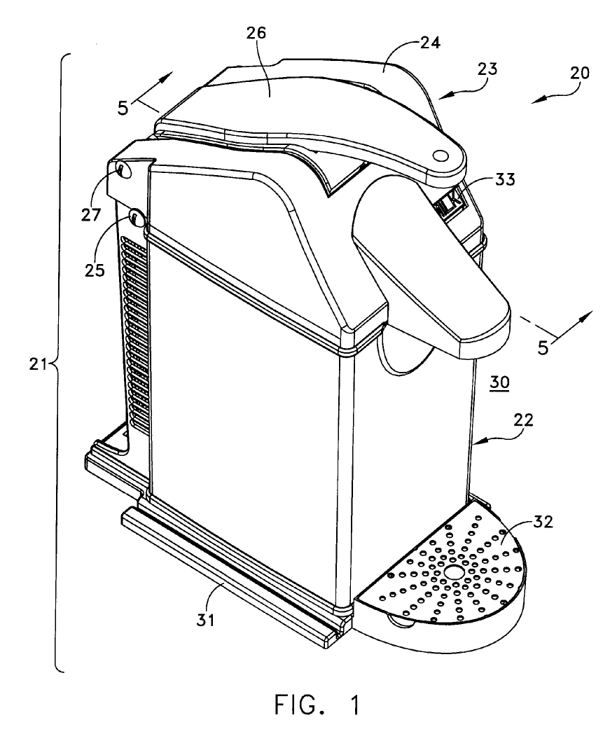

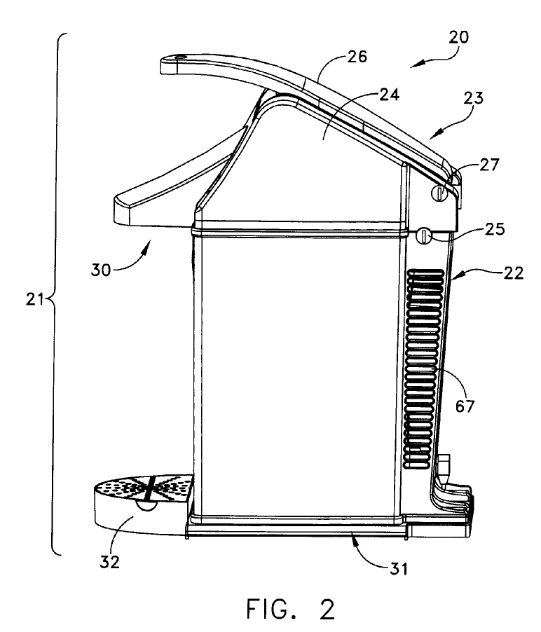

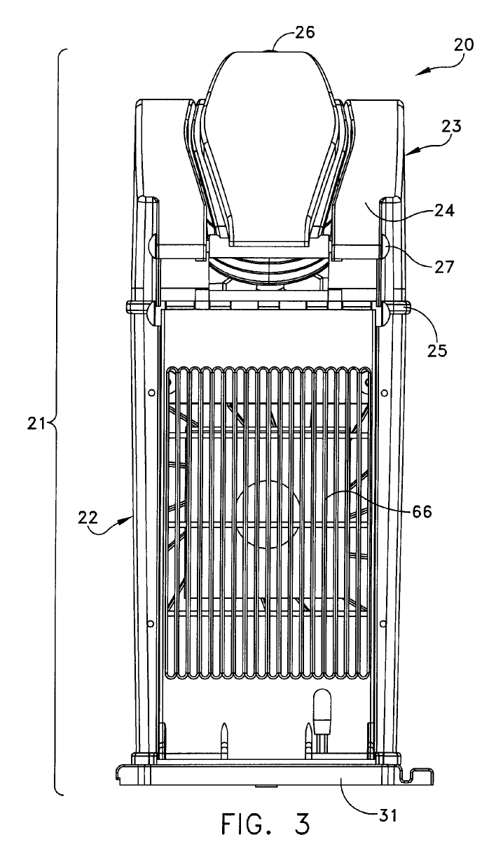

FIGS. 1 through 3 depict a beverage dispenser 20 that refrigerates a packaged beverage and facilitates the dispensing of that beverage. In one specific application, the beverage dispenser 20 may include a container or carton of milk for being dispensed into coffee or tea in a cup. It will become apparent that this invention can be implemented as a dispenser for a wide variety of liquids and containers, although its primary application will be for beverages.

The beverage dispenser 20 includes a covered refrigerated housing 21 that includes an outer housing 22 and cover 23. The cover 23 includes a cover body 24 that rotates about a cover body hinge 25. In addition, the cover body 24 supports an actuator 26 that rotates about an actuator hinge 27 attached to the cover body 24. Liquid exits the beverage dispenser 20 at a dispensing position 30.

Still referring to FIGS. 1 through 3, the beverage dispenser 20 includes a base unit 31 with a drip basin assembly 32. The base unit 31 supports housing 21. The drip basin assembly 32 collects any beverage that may be spilled accidentally during use. The beverage dispenser 20 also contains indicia 33 for identifying the nature of the contents as, for example, milk, cream and half-and-half.

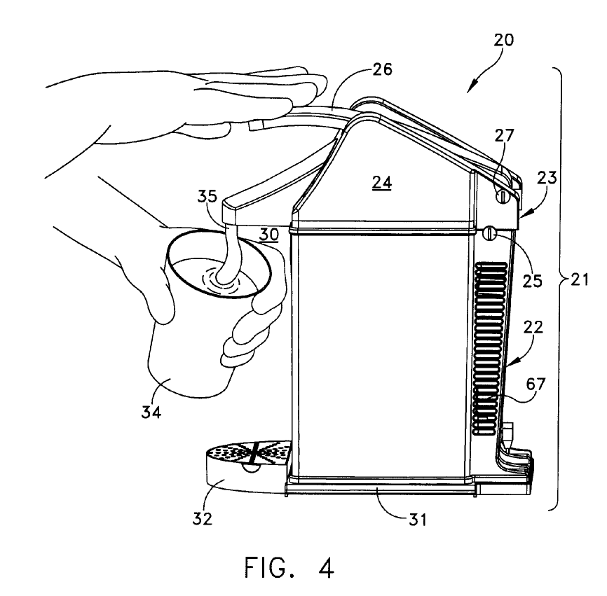

Referring now to FIG. 4, in use the consumer positions a cup 34 at the dispensing position 30. Then the consumer depresses the actuator 26 to dispense the liquid in a stream 35 into the cup 34. When the consumer depresses the actuator 26, the beverage dispenser produces a pressure differential that forces the chilled liquid from a container to be dispensed at the dispensing position 30. The beverage dispenser 20 comprises a number of the major assemblies to achieve this operation. These assemblies include the covered refrigerated housing 21 with subassemblies including the outer housing 22 and cover 23, a dispensing assembly that conveys the liquid from its container to the dispensing position 30, and a pressure differential enabling assembly that includes the actuator 26. When the consumer releases the actuator 26 after having dispensed a desired amount, the actuator 26 returns to the position shown in FIGS. 1 through 3. This terminates the flow of liquid as described hereinafter. Each of the foregoing assemblies will now be discussed in detail.

Covered Refrigerated Housing 21

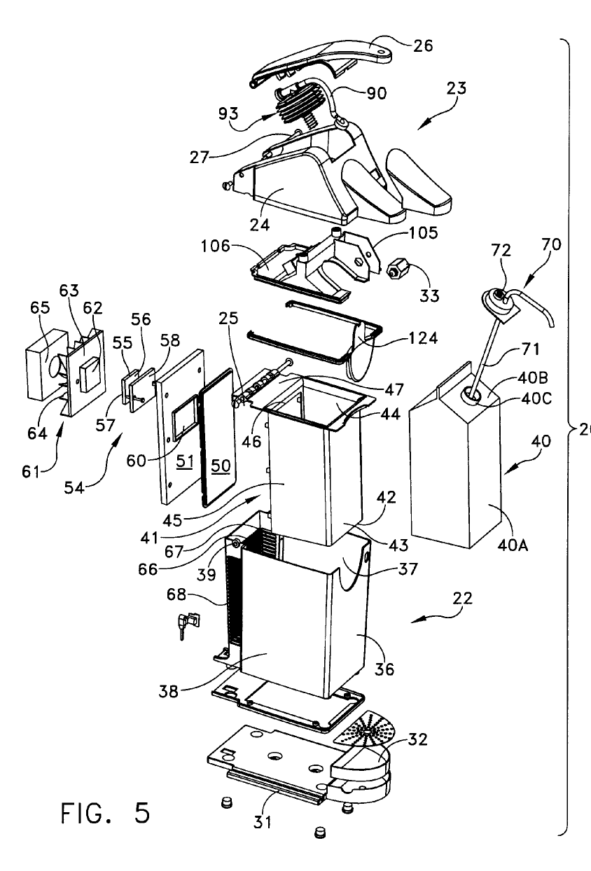

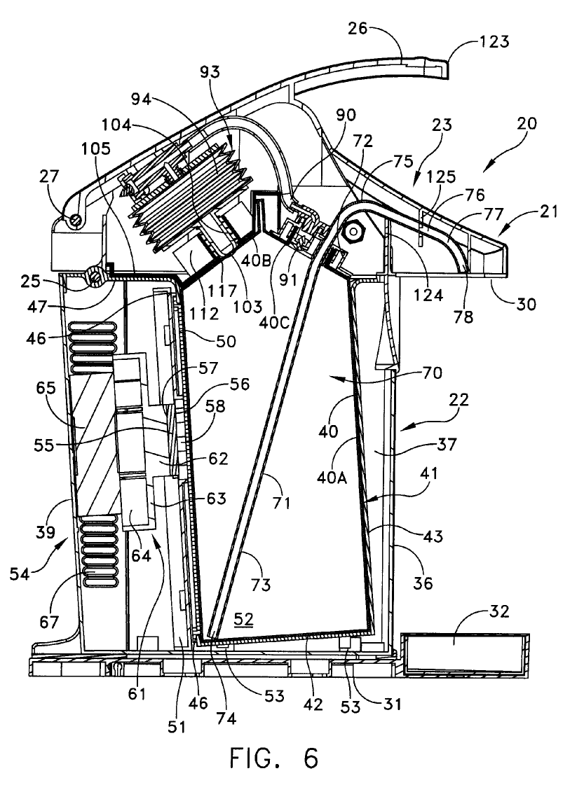

Referring now to FIGS. 5 and 6, the covered refrigerator housing 21 receives a liquid container and maintains the liquid at a predetermined temperature. In this specific embodiment, the outer housing 22 includes a front wall 36, a right side wall 37, a left side wall 38 and a rear wall 39 that spans the right and left side walls 37 and 38.

This outer housing 22 supports a holder for a liquid container, such as a milk or cream carton 40, by means of an inner sleeve 41 with a bottom 42, a front wall 43, and right and left side walls 44 and 45. A rear frame 46 includes a top extension 47 that carries the hinge 25 for the cover 23. A thermally conducting plate 50 formed, for example, of aluminum mounts to a rear wall 51 to span and closes the back of the sleeve 41. Collectively, the elements 41 through 50 form a closed bottom inner sleeve that receives a liquid container, namely the carton 40 in the embodiment shown in FIGS. 5 and 6.

As will be apparent, in any specific implementation the sleeve 41 will be sized and configured to conform to a specific carton 40. In this embodiment, the carton 40 is a half-gallon carton and has a square bottom section 40A and roof-shaped top 40B with a spout 40C, normally closed by a cap that is not shown. In addition, the sleeve 41 may be canted, as shown in FIG. 6 to lie along an axis that slopes from a forward position at the bottom to a rearward position at the top. Canting assures that the carton 40 forms a low area 52 that enables essentially all the liquid in the carton 40 to be dispensed. A portion of the weight of the carton, and its contents, will act to produce intimate contact between one wall of the carton 40 and the cold plate 50 to maximize heat transfer efficiency. Feet or supports 53 (FIG. 6) of different heights provide one means for canting the sleeve 41.

Still referring to FIGS. 5 and 6, the cold plate 50 constitutes one element of a heat exchanger 54 that, in this embodiment includes a thermoelectric refrigeration unit located intermediate the outer housing 22 and the inner sleeve 41. The heat exchanger 54 maintains the contents of the carton 40 at a predetermined temperature that preserves the freshness of the liquid. More specifically, an electrically powered Peltier thermoelectric refrigeration unit 55 has a cold side 56 and a hot side 57. The cold side 56 mounts to a block 58 that extends through an access window 60 in the back wall 51 to contact the cold plate 50.

An air cooled heat sink 61 includes a body portion 62 that extends from a mounting plate 63 for a set of radial fins 64 to the hot side 57 of the Peltier unit 55. A fan 65, shown in FIG. 6, establishes air flow from the exterior of the dispenser 20 through a back grate 66 and across the radial fins 64 to exit through right and left side grates 67 and 68.

As will now be apparent, when the Peltier thermoelectric refrigeration unit 55 is energized by an electric power supply, not shown but well known to those skilled in the art, heat transfers from the liquid in the carton 40 through the cold plate 50 and mounting block 58 into the semiconductor that constitutes current passing through the semiconductor converts the thermal energy into a flow of electrons which are converted back into thermal energy on the “hot” face 57 of the semiconductor. The fan 65 blows ambient air across the heat sink comprising the radial fins 64 to absorbing the thermal energy thereby completing the heat exchange process. As will also be apparent, the dispenser 20 may also include temperature sensors and circuitry for controlling the energization of the Peltier thermoelectric refrigeration unit 55 to maintain the liquid in the carton 40 at a predetermined temperature.

Dispensing Assembly

As previously indicated, the beverage dispenser 20 includes a dispensing assembly 70 that directs liquid from the carton 40 to the dispensing position 30. As shown in FIGS. 5 through 7, a preferred embodiment of the dispensing assembly 70 comprises an integrally formed dispensing tube 71 and cap 72 that is particularly appropriate for reducing maintenance and cleaning costs.

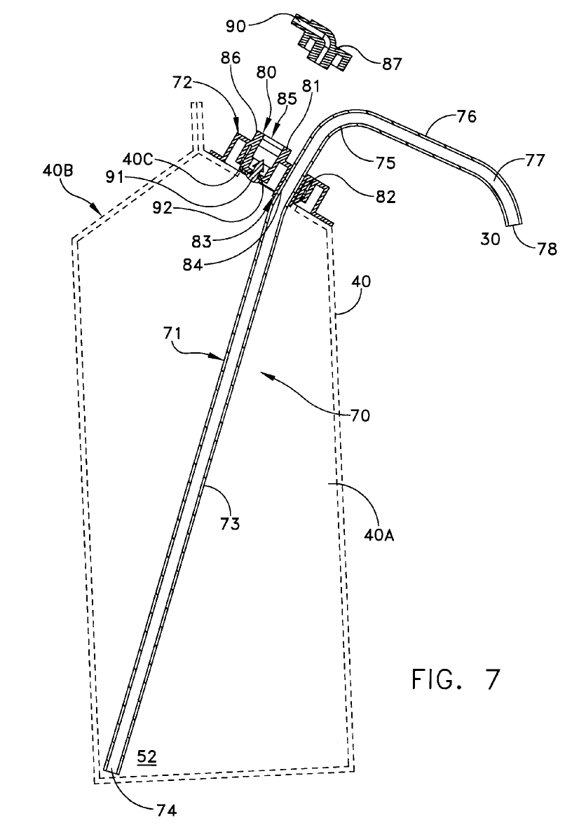

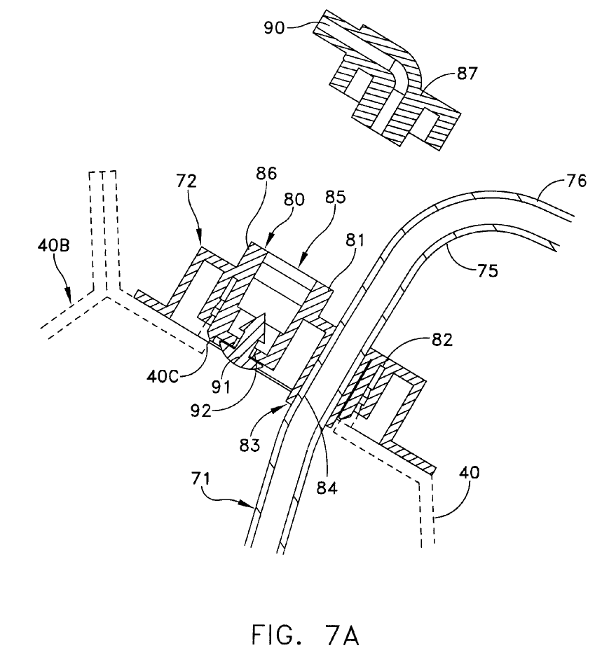

Referring to FIGS. 6 and 7, the dispensing tube 71 has an inverted J-shape and includes a main leg portion 73 with an inlet 74 at one end. The dispensing tube 71 extends from other end of the main leg portion 73 through a radiused portion 75, a lateral extension 76 and a curved output section 77 to end at a dispensing outlet 78.

The cap 72 is formed as a generally cylindrical fitting 80 having a body 81 with an annular groove 82. This construction enables the fitting to be snapped or otherwise attached to the spout 40C (shown in phantom in FIG. 7). The cap 72 has a first port 83 through which the dispensing tube assembly 70 extends. The dispensing tube assembly 70 is sealed to the cap 72 at the first port 83. This structure then provides a closed path from the interior of the carton 40 to the dispensing outlet 78 through the first port 83, specifically a passage 84.

A second port 85 provides a passage through the cap 72 whereby pressure can be applied to the interior of the carton 40. In this specific embodiment, the second port 85 includes a male input fitting 86 for receiving a female fitting 87 attached to one end of an air pump hose 90. The passage through the second port 85 includes a one-way valve 91 that can close passages 92. When pressure is applied through the tubing 90, the valve 91 opens. When the pressure on the liquid in the carton 40 exceeds the pressure in the tubing 90, the valve 91 closes and blocks any transfer of air or entrained liquid from entering the tubing 90 through the passages 92.

Pressure Differential Enabling Assembly

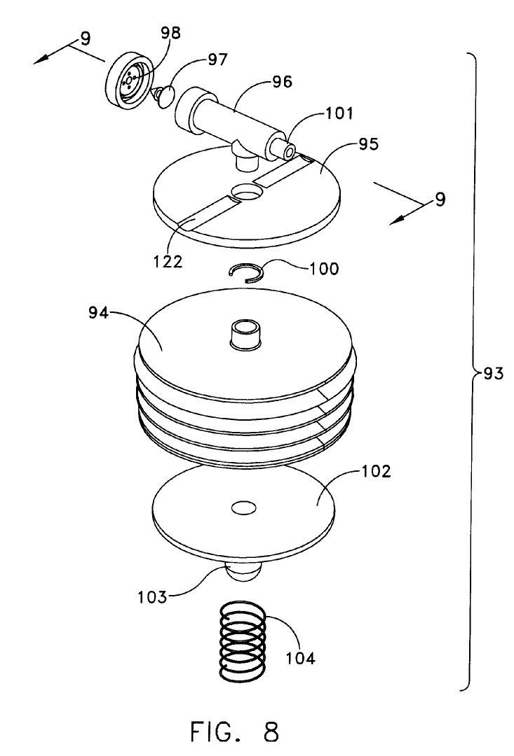

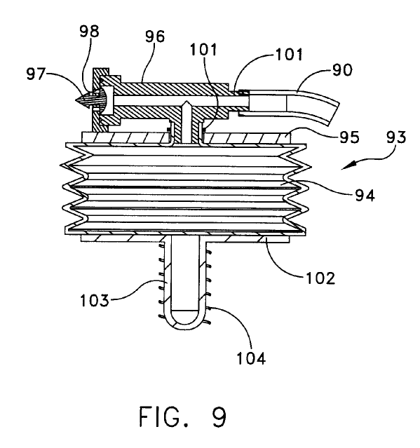

Referring to FIGS. 5 and 6, in this embodiment a manually operated air pump 93 increases the air pressure in the carton 40 to dispense a portion of the contents at the dispensing position 30. The air pump 93 is a bellows pump disclosed in detail in FIGS. 8 and 9. A bellows 94 attaches to a top plate 95 and a valve body 96. The valve body 96, at one end, carries a one-way valve 97 that controls air flow through air passages 98. A C-ring 100, or other equivalent fastening device, connects the valve body 96 and bellows 94 together. At the other end, the valve body 96 forms a connector 101 for the air hose 90.

The bellows 94 is sandwiched between the top plate 95 and a bottom plate 102 that includes an axial extension 103. A spring 104 surrounds the axial extension. As will be apparent, compressing the bellows 94 increases the internal pressure so the valve 97 closes. Air is pumped through the hose 90 and into the carton 40 shown in FIGS. 5 and 6. When the bellows 94 expands, the valve 97 opens and admits air into the bellows 94.

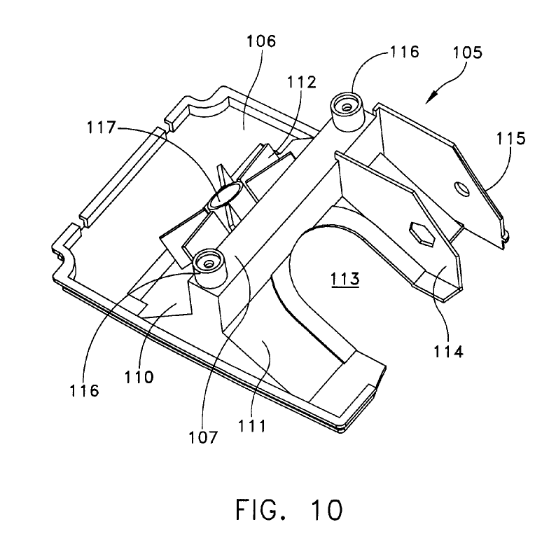

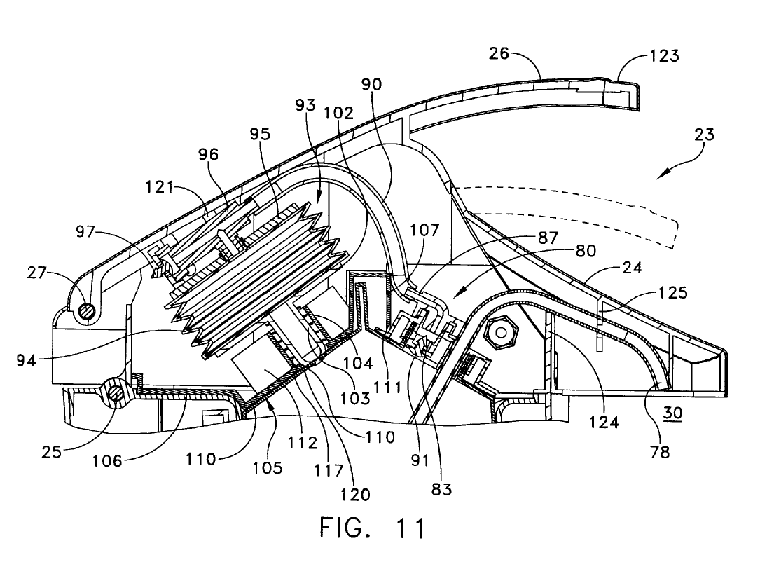

As shown in FIGS. 5 and 6, the cover 23 carries the air pump 93. More specifically, an internal lid 105 spans the bottom of the cover body 24. As shown in more detail in FIGS. 10 and 11, the internal lid has a flat portion 106 that overlies the top extension 47 in FIG. 5. A middle channel 107 lies at the apex of converging ramp portions 110 and 111. The ramp portions 110 and 111 produce a truncated triangular space below the internal lid 105 to conform to the roof 40B shown in FIG. 5.

Still referring to FIGS. 10 and 11, the ramp portion 110 includes a base 112 that supports the air pump 93. In this particular embodiment the base 112 comprises a plurality of radially extending ribs. It will be apparent, however, that the exact structure is not critical to performing the function of supporting the air pump 93.

The ramp portion 111 includes a central U-shaped cutout portion 113 and, to one side, parallel walls 114 and 115 that support the indicia 33 shown in FIG. 1. Mounts 116 provide a means for positioning and fastening the internal lid 105 to the cover body 24.

The base 112 includes a central passage 117. As shown most clearly in FIG. 11, the axial extension 103 and spring 104 lie in the passage 117 when the air pump 93 is in position. A collar portion 120 at the lower end of the passage 117 blocks any advance of the spring 104 while allowing the axial extension 103 to move in the passage 117 so that the air pump 93 floats in the base 112.

Operation

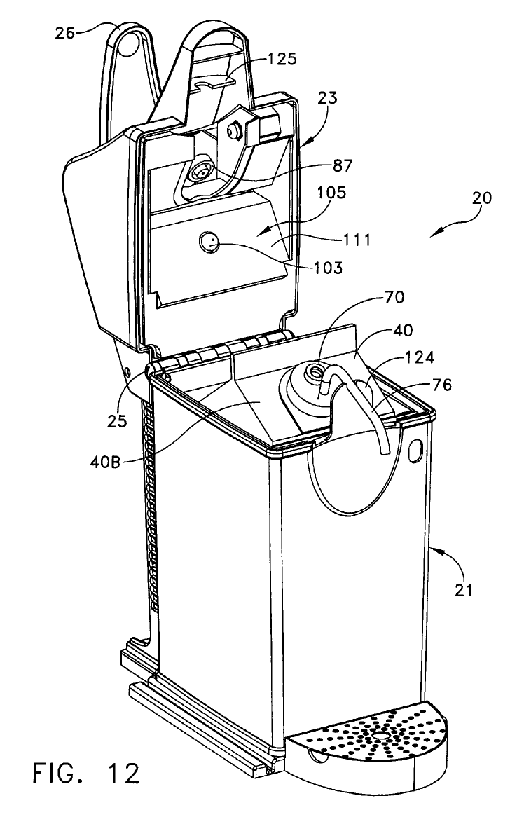

The operation of the beverage dispenser 20 can now be discussed with particular reference to FIGS. 11, 12 and 13. When it becomes necessary to exchange a carton, the cover 23 and actuator 26 rotate to a position shown in FIG. 12. This exposes the carton roof 40B and the disposable dispenser assembly 70. In addition, as shown in FIG. 12, when the cover 23 is rotated, the hose fitting 87 and the tip of the axial extension 103 are become readily accessible. Next the disposable dispenser assembly 70 is removed. Should the dispenser assembly 70 be reusable, it is cleaned. The old carton 40 is removed and a new, full carton is inserted. Any cap on the spout 40C is removed. The carton 40 then lies within the sleeve 41 and is canted to be in contact and abut the cold plate 50 shown in FIG. 6.

Next the dispenser assembly 70 is inserted through the spout 40C. The lateral extension 76 of the dispenser assembly 70 is positioned in a support 124 to provide lateral and vertical stability. Next the cover 23 is closed. This positions another rib or wall 125 to straddle the extension 76 as specifically shown. This further stabilizes the position of the extension 76.

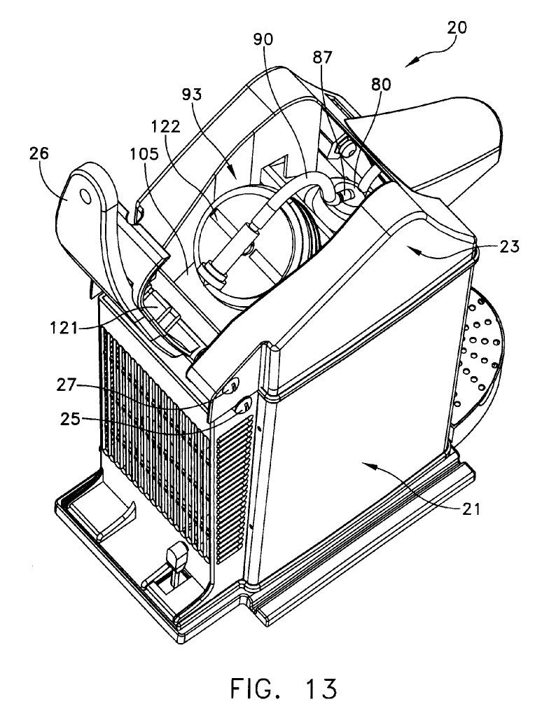

Referring now particularly to FIG. 13, the actuator 26 remains in a retracted position when the cover 23 closes. Consequently there is access to allow the hose filling 87 to be attached to the fitting 80 particularly to the second port 85 as shown in FIG. 11.

FIG. 13 also depicts fingers 121 and the depressions 122 in the air pump 93. After the air hose 90 is connected to the fitting 80, the actuator 26 is rotated clockwise as shown in FIG. 13 to the position shown in FIGS. 6 and 11 to bring the ends of the fingers 121 into contact with the depressions 122. This provides a link between the actuator 26 and the air pump 93. Then the beverage dispenser 20 is ready to use. At that point consumers can dispense beverages such as milk or cream from the dispenser 20 as previously described merely by depressing the actuator 26.

Referring to FIGS. 6 and 11, depressing an end 123 of the actuator 26, there is a compound motion of the bellows air pump 93. As a first component, the bellows 94 compresses to increase the internal air pressure on the surface of the liquid in the carton 40 through the first port 83. The second component is a translation motion of the air pump 93 relative to the body 112. This motion displaces the axial extension 103 to deform the carton roof 40B. The remainder of the carton 40 is constrained either by the nature of its construction or the sleeve 41. Consequently, this deformation reduces the internal volume of the carton 40 with a concomitant increase in pressure on the liquid.

At some point during the depression of the actuator 26, the air pressure on the liquid increases sufficiently to overcome any pressure drop in the dispensing tube 71 and the pressure difference that exists between the level of the liquid in the carton 40 and the dispensing outlet 78. When this occurs, liquid flows through the dispensing tube 71 to exit at the dispensing position 30.

Releasing the actuator 26 after dispensing a sufficient quantity of the liquid produces a reverse compound motion. The spring 104 drives the bellows air pump 93 away from the carton as one component of the motion. As a second component, the internal memory of the bellows material expands the bellows 94. This produces a rapid pressure drop on the liquid surface to stop the flow of liquid at the dispensing position 30. Initially the pressure drop produced by the expansion of the bellows will exceed the pressure drop produced by the expansion of the carton 40. This closes the valve 91 to block any entrained liquid from entering the air hose 90 and components of the air pump 03. Eventually the pressure on the liquid returns to atmospheric pressure whereupon the valve 91 opens.

The valve 91 also minimizes the risk of liquid entering the air hose 90 and air pump 93 should the dispenser 20 be tilted with a liquid containing carton 40 in place. Initial contact of any liquid with the fitting 80 will quickly close the valve 91. Some liquid might contact the fitting 80, but the amount of liquid passing the valve 91 before it closes will be insufficient to travel to the air pump 93.

As will now be apparent, the beverage dispenser 20 refrigerates a beverage or liquid and dispenses that beverage in a controlled manner. Cleaning operations are minimized. Moreover, as will be apparent the construction and assembly of the dispenser 20 minimizes costs thereby to make the beverage dispenser affordable for use in coffee shops and like businesses.

### Alternative Embodiments

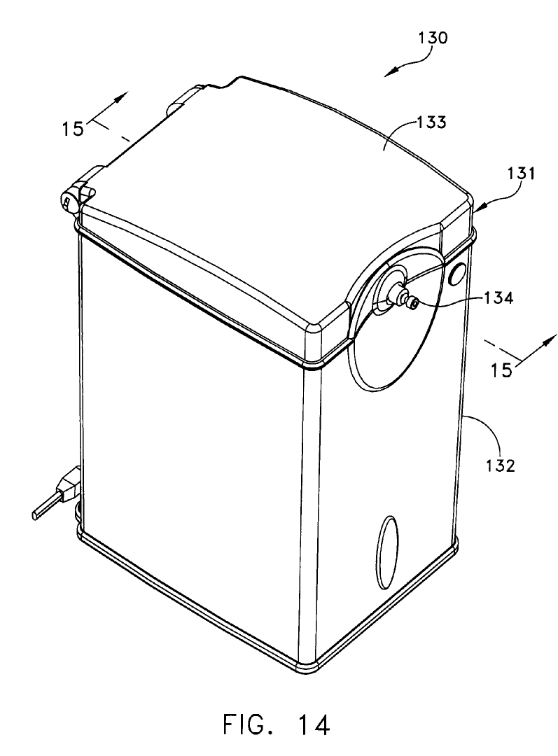

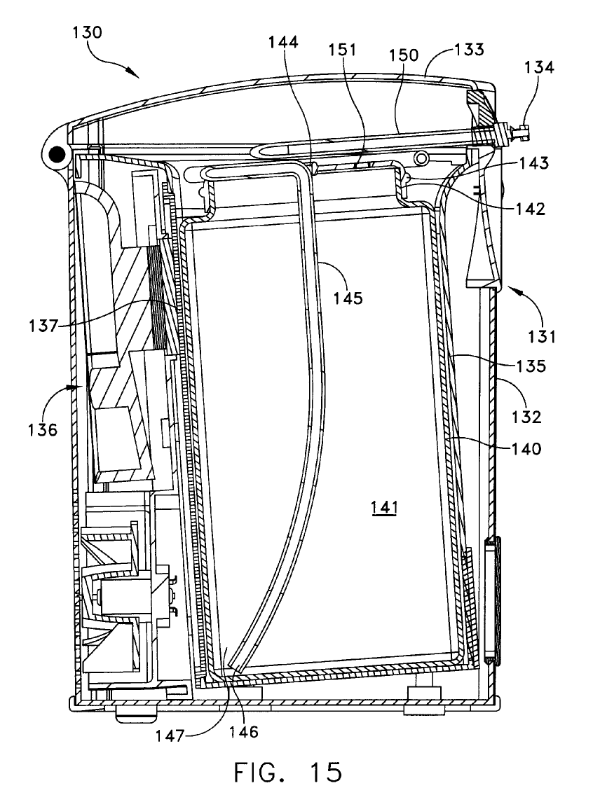

The beverage dispenser shown in FIGS. 1 through 13 produces a pressure differential by means of an air pump thereby to pressurize the interior of the carton 40 with respect to ambient air pressure at the dispensing position 30. FIGS. 14 and 15 depict an alternative beverage dispenser 130 that is adapted for use with a Venturi mixing device, such as shown in espresso machines. The beverage dispenser 130 includes a covered refrigerated housing 131 formed by an outer housing 132 and a cover 133. A fitting 134 is adapted for connection to a Venturi mixing device by a hose or other fluid conduit not shown but known in the art.

Referring specifically to FIG. 15, the outer housing 132 carries an inner sleeve 135 that is canted to the rear. A heat exchanger 136 having a structure corresponding to the structure in FIGS. 1 through 13 includes a cold plate 137. Thus while the heat exchanger 136 is energized, contents of a container 140 remain chilled.

In this particular embodiment, the container 140 is reusable. It includes a main volume 141 for the liquid to be dispensed and a spout 142. A cap 143, when removed, allows the container 140 to be filled. Removable of the cap also facilitates cleaning of the container 140 so in this embodiment the container 140 is reusable.

The cap 147 has a first port 144 that receives a dispensing tube 146. The dispensing tube 146 curves to a bottom inlet portion 146 at a low area 147 of the canted container 140. The dispensing tube 145 exits the container 140 and the cap 143 and connects through a hose 150 to the outlet dispensing fitting 134. The cap 143 additionally includes a second port in the form of a passage 151. Thus when the steam generator in the coffee making apparatus operates, the pressure at the Venturi mixing device reduces. The second port or passage 151, however, maintains the ambient pressure on any liquid in the container 140. Consequently a pressure differential exists that causes liquid in the container to travel through the dispensing tube 145 and the hose 150 to be entrained with steam passing through the Venturi mixing device. When operation terminates, the pressure equalizes and flow stops.

Thus it will be apparent that the embodiment in FIGS. 14 and 15 provides a beverage dispenser that refrigerates a beverage and dispenses that beverage in a controlled manner. The structure is also affordable for use in coffee shops and like businesses, particularly because the container 140 and dispensing tube 145 can be reused.

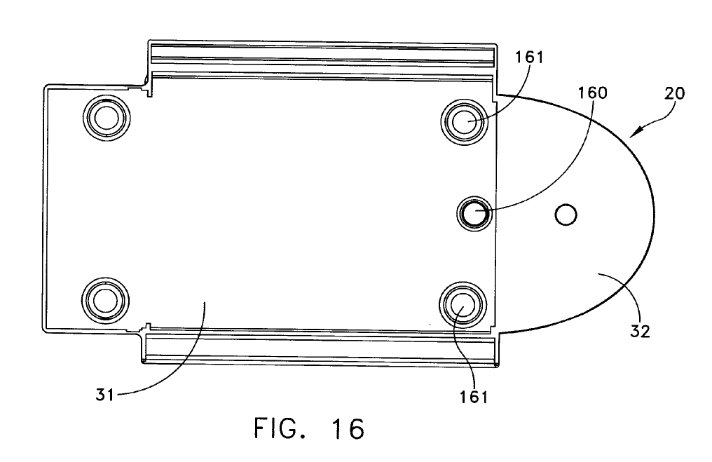

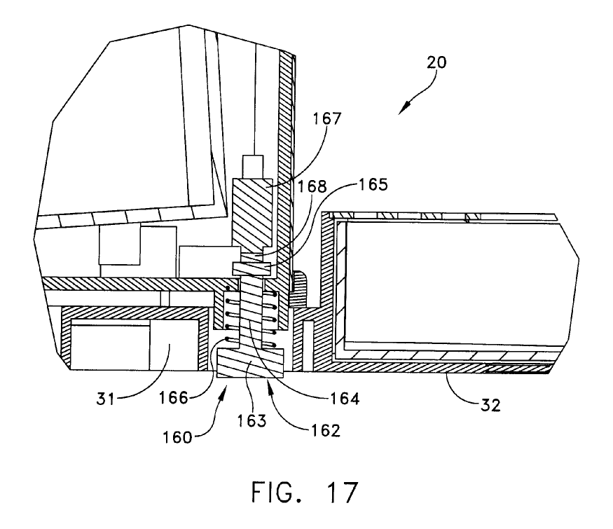

In another embodiment either the dispenser 20 of FIGS. 1 through 12 or the dispenser 130 of FIGS. 14 and 15 can be incorporate an annunciator for alerting personnel to replenish the contents of the dispenser. Using the dispenser 20 as an example and referring to FIGS. 16 and 17, an annunciator 160 can be located in the base unit 31 adjacent the drip basin 32 centrally between front feet 161. The annunciator 160 includes a piston 162 having a foot 163, intermediate shaft 164 and head 165 positioned in the base unit 31. A spring 166 surrounds the shaft 164 and biases the piston 162 downward in the orientation shown in FIG. 17. The head 165 engages an actuator 168 from a microswitch 167.

When the container is full, the total weight of the dispenser 20 produces a downward force that compresses the spring 166 and causes the head 165 to drive the actuator 168 upward in FIG. 17 to establish a first switch state. As the liquid is consumed, the downward force reduces. The spring 166 and position of the microswitch 167 are calibrated so that the microswitch 167 shifts to a second state when the liquid weight reduces to a volume requiring replenishment. At that weight, the spring 166 expands and displaces the piston 162 away from the microswitch 167. The state of the microswitch 167 then indicates the need for replenishment. Any of a variety of visual, audio or audiovisual outputs can then announce this need.

It will now be apparent that this invention can be implemented with diverse structures. Two specific structures have been shown. The specific implementations can be modified by relocation or other equivalent structures. Thus, while this invention has been disclosed in terms of certain embodiments, it will be apparent that many modifications can be made to the disclosed apparatus without departing from the invention. Therefore, it is the intent of the appended claims to cover all such variations and modifications as come within the true spirit and scope of this invention.

What is claimed is:

1. Apparatus for dispensing the contents of a liquid container comprising:
A) covered, refrigerated housing means for receiving the container,
B) port means for forming first and second ports in the liquid container,
C) dispensing means extending from the interior of the liquid container to a dispensing outlet at the exterior of said housing through said first port,
D) pressure differential enabling means attached to said housing and including said second port for increasing the pressure on the liquid container over the pressure at said dispensing outlet whereby operation of said pressure differential enabling means enables liquid to be dispensed from said liquid container at said dispensing outlet.

2. Dispensing apparatus as recited in claim 1 wherein said housing means includes an outer housing and an inner sleeve for receiving the liquid container.

3. Dispensing apparatus as recited in claim 2 wherein said outer housing has a rear wall and said inner sleeve is canted to position the top of said inner sleeve closer to said outer housing rear wall than a bottom of said inner sleeve.

4. Dispensing apparatus as recited in claim 2 wherein said inner sleeve has a thermally conducting wall for contacting the liquid container and said housing means includes heat exchanging means intermediate said outer housing and said inner sleeve for cooling said thermally conducting wall.

5. Dispensing apparatus as recited in claim 4 wherein said heat exchanger includes:
i. a thermoelectric refrigeration unit and a cold plate connected to one side thereof, said cold plate being in contact with said inner sleeve rear wall,
ii. a heat sink connected to the other side of said thermoelectric refrigeration unit,
iii. a fan, and
iv. flow direction means of said housing for facilitating the flow of air produced by said fan across said heat sink.

6. Dispensing apparatus as recited in claim 2 wherein dispensing means includes a dispensing tube extending through said first port from the bottom of the liquid container to the dispensing outlet and said housing means includes means for supporting said dispensing tube exteriorly of said housing means.

7. Dispensing apparatus as recited in claim 6 wherein said dispensing tube and said port means form a removable subassembly.

8. Dispensing apparatus as recited in claim 6 wherein said dispensing tube has an inverted J-shape with an elongated leg extending through said first port and a reverse portion for attached to said support means for directing liquid downwardly to said dispensing outlet.

9. Dispensing apparatus as recited in claim 6 wherein said dispensing tube includes a fitting at the dispensing outlet for connection to a suction means for withdrawing liquid from the liquid container through said dispensing tube.

10. Dispensing apparatus as recited in claim 2 wherein said pressure differential means includes an air pump for producing the differential pressure.

11. Dispensing apparatus as recited in claim 2 wherein said outer housing has an open top and said housing means includes a cover hinged to said outer housing for rotation between an open position for enabling the insertion and removal of the liquid container from said housing means and a closed position for covering the outer housing.

12. Dispensing apparatus as recited in claim 11 wherein said cover includes a cover body, an air pump attached to said cover, said actuator being hinged for rotation independently of said cover body to engage said air pump thereby to enable operation of said dispensing apparatus.

13. Dispensing apparatus as recited in claim 12 wherein said air pump includes a bellows pump and said cover includes means for supporting said bellows pump for vertical deflection, said actuator being pivoted about said housing whereby depression of said actuator operates said bellows pump and deflects said support means to compress the carton.

14. Dispensing apparatus for chilled liquids in a liquid container with a spout comprising:
A) an outer housing,
B) a thermoelectric heat exchanger in said housing having a cold side and a hot side wherein a heat sink attaches to the hot side and a fan directs air across the heat sink,
C) a sleeve for receiving the liquid container having a portion thereof in contact with said cold side thereby to chill the liquid in the liquid container,
D) a fitting for engaging the liquid container spout and closing the opening through the spout, said fitting including pressurization and dispensing tube ports therethrough,
E) a manually operated air pump attached to said outer housing for directing air under pressure through said pressurization port,
F) a dispensing tube extending from a bottom portion of the liquid container through said dispensing tube port to a dispensing outlet whereby operation of said air pump causes liquid in the liquid container to be dispensed from said dispensing apparatus at said dispensing outlet.

15. Dispensing apparatus as recited in claim 14 wherein said air pump includes a bellows pump and said outer housing includes cover means for supporting said bellows pump adjacent the top of said outer housing, said apparatus including an actuator independently hinged to said cover whereby depression of said actuator compresses said bellows pump forcing liquid to be dispensed from said dispensing outlet.

16. Dispensing apparatus as recited in claim 14 wherein said sleeve is canted in said outer housing and said dispensing tube extends to the lowest portion of the liquid container.

17. Dispensing apparatus as recited in claim 14 wherein said bellows has an output port and a flexible conduit connects between said output port and said pressurization port and wherein said pressurization port includes a one-way check valve that opens when said bellows pump is compressed.

18. Dispensing apparatus as recited in claim 14 wherein said fitting and said dispensing tube are formed as a single subassembly.

19. Dispensing apparatus as recited in claim 14 including indicia means for indicating the specific liquid in the liquid container.

20. Dispensing apparatus as recited in claim 14 including means for indicating a need for replacing the liquid container in the sleeve with another liquid container.
